(19) United States
(12) Patent Application Publication
(10) Pub. No.: US 2008/0285405 A1
(43) Pub. Date: Nov. 20, 2008

(54) Playback Device For Information Data Sets

(75) Inventor: Andreas Lotz, Asslar-Berghausen (DE)

Correspondence Address: WPAT, PC, 7225 BEVERLY ST., ANNANDALE, VA, 22003, US

(73) Assignee: KONINKLIJKE PHILIPS ELECTRONIC, N.V., Eindhoven (NL)

(21) Appl. No.: 10/597,217

(22) PCT Filed: Jan. 11, 2005
(86) PCT No.: PCT/IB2005/050115

§ 371 Date: Aug. 4, 2008

(30) Foreign Application Priority Data
Jan. 19, 2004 (EP) 04100450.4

(51) Int. Cl. G11B 27/10

(52) U.S. Cl. 369/47.28

(57) ABSTRACT

A playback device for information data sets with a microphone, a memory arrangement, and a control unit. The audio markers are recorded with the microphone. The memory arrangement stores the audio markers in association with the respective information data sets. Furthermore, a control unit is coupled to the memory arrangement and to the microphone. In the method of operating the playback device for information data sets, the recognition of an information data set without an associated audio marker triggers the recording of an audio marker, and the newly recorded audio marker is stored in association with the relevant information data set.

The invention relates to a playback device for information data sets and to a method of operating such a playback device.

Playback devices for information data sets, for example CD, DVD, MD playback devices, car radios with CD playback units, MP3 players, CD recorders possibly with hard disks, etc., comprise remote controls on the devices themselves for their operation. Controls are often integrated into the steering wheel of the automobile in the case of car radios so as to improve the operation of the car radio in the sense that the driver can operate the car radio without removing his/her attention from the road. If a car radio has more complicated functions, however, an interaction with the car radio will only be possible via the display of the car radio and the accompanying controls.

It is accordingly an object of the present invention to provide a playback device for information data sets and a method of operating such a playback device wherein the ease of operation of the playback device is enhanced.

An information data set here is, for example, a sequence of musical tracks, songs or spoken text in the PCM or MP3 format, wherein one such sequence may constitute only a single item (one song).

The memory unit may comprise one or several memory modules, and it may be provided that the memory unit or one memory module can be taken from the playback device.

It is a feature of a microphone that it can convert acoustic waves into electromagnetic signals. Thus a loudspeaker operated in the inverse mode is also to be understood to be a microphone.

A playback device as claimed in claim 1 offers the possibility of managing a large number of information data sets and of facilitating the choice for the user afterwards in that an audio marker is recorded via the microphone for each information data set and is stored in association with the relevant one information data set. The control unit then recognizes when an information data set has no associated stored audio marker and accordingly activates the microphone for recording an audio marker. The user is visually or acoustically made aware of the fact that a recording of an audio marker is to be made. Future access to the information data sets then takes place, for example, by listening to the audio markers and selecting an information data set on the basis of the contents of the audio marker. This means that the user need not interact with the playback device via a badly readable display or by means of a plurality of control elements.

In a further embodiment, the playback device comprises a loudspeaker. A user can now trigger the playback of the stored audio markers by pressing a START button. Subsequently, the user selects the information data set with which the audio marker is associated by once more pressing the START button or by pressing a PLAY button. An information data set may thus be selected, in particular in a motor vehicle ambience, without the necessity of the user diverting his/her visual attention from the road. Without the associated, stored audio marker, the user would have to watch, for example, a display so as to inspect the possible selection of information data sets and to choose one of the information data sets.

It is a feature of a loudspeaker that it converts electromagnetic signals into acoustic waves.

In a further embodiment, at least one of the information data sets is stored in the memory device. Information data sets not thus stored may be present, for example, on optical data carriers. In the playback device according to the invention, therefore, one or several optical data carriers may be present (playback device with data carrier exchange function). In a further embodiment, a reading unit is present for reading the information data sets from an optical data carrier, which unit is also coupled to the control unit. The optical data carriers may be CDs or DVDs.

In an alternative embodiment, there is a user interface with at least one control element for selecting an information data set. The user can select the information data set belonging to the audio marker just being played during the playback of the audio markers by means of the control element of the user interface. Such a control element may be mounted to the playback device itself, it may be provided on the steering wheel in a motor vehicle ambience, or it may be a microphone for recording a spoken command. The control element enables the user to influence the playback device, whereby a selection of an information data set is made possible.

In further embodiments of the playback device according to the invention, there is an analog-to-digital converter which converts the recorded audio markers from their analog form into a digital form, a digital-to-analog converter which converts the digital form of the audio markers into an analog form again so that they can be played back through a loudspeaker, and a converter unit which compresses the information data sets before storage in the memory arrangement and decompresses them again after read-out from the memory arrangement, so that the memory space in the memory arrangement can be utilized particularly effectively. The compression process may be a process with losses and/or a loss-free compression process. This renders possible first the compression with losses of PCM audio data into the MP3 format, and subsequently the compression by means of a loss-free compression process, for example into the ZIP format.

In a further embodiment, a memory module of the memory arrangement is constructed such that it can be removed from the playback device. Said memory module may also comprise the entire memory arrangement and may be realized, for example, as a flash memory card or microdrive or hard disk drive. This may be achieved in a motor vehicle ambiance, for example, by means of a slide compartment at the front of the playback device, while the memory module is provided with connecting elements so that a connection for the data exchange with the playback device is created during insertion into the slide compartment.

The invention furthermore relates to a method of operating a playback device for information data sets.

The invention will be explained in more detail below with reference to embodiments and the appended Figures, in which:

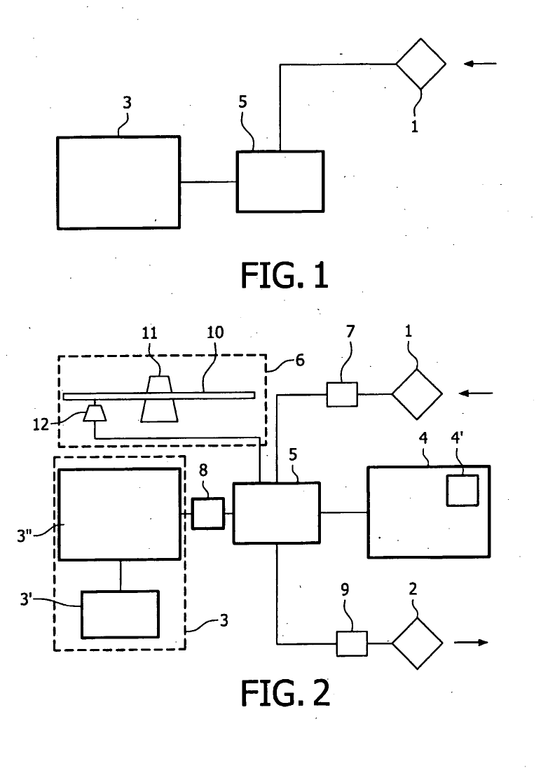

FIG. 1 shows the essential elements of a playback device according to the invention,

FIG. 2 shows a playback device according to the invention in a more detailed embodiment, and

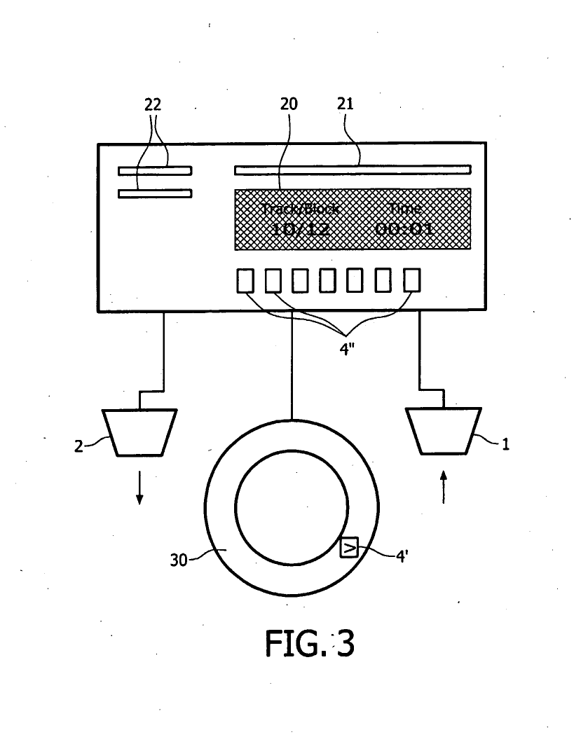

FIG. 3 shows a playback device according to the invention for a motor vehicle application.

FIG. 1 shows the essential features of a playback device according to the invention for information data sets. The playback device comprises a microphone 1. The microphone 1 serves to record sound, essentially spoken language. According to the invention, the microphone 1 serves to record audio markers, i.e. acoustic sequences limited in time, which are associated with information data sets. The microphone 1, however, need not be restricted to this function. As will be described further below, it may also be used for recording audio commands in a speech-controlled user interface, or fulfill other functions which are typical of a microphone. The use of several microphones, for example micro-phones arranged around a user so as to improve the recording quality, or of several microphones of which one records the audio markers and another one, for example, records spoken commands, is equally conceivable. The playback device according to the invention shown in FIG. 1 also comprises a memory arrangement 3. Information data sets can be stored in the memory arrangement. An information data set may be the complete contents of one CD, or an information data set may be formed by a single track (song). The memory arrangement may consist of a plurality of individual memories or of only one memory unit. A control unit 5 is coupled both to the microphone 1 and to the memory device 3. The control unit 5 is constructed such that it activates the microphone 1 for recording an audio marker and subsequently stores this audio marker in the memory device 3 in a manner associated with a respective information data set.

FIG. 2 shows a playback device according to the invention in a more detailed embodiment. The playback device of FIG. 2 comprises a memory unit 3 which consists of a plurality of memory modules 3′, 3″. In an embodiment, at least one memory module 3′, 3″, or the entire memory unit 3, can be removed from the playback device. This may be realized, for example, in that the memory arrangement 3 or one of the memory modules 3′ or 3″ is constructed as a flash memory card or as a hard disk drive (HDD). If the playback device is constructed, for example, as a car radio, such a memory module 3′ may be inserted at the front and may be connected such that it can be readily inserted and pulled out again. It is also possible in this manner to write information data sets onto the removable memory module in a different device, whereupon said data sets are reproduced by the playback device. The control unit 5 then recognizes during operation that information data sets have been stored on the memory module 3′ to which no audio markers have been assigned. The user is then invited to record an audio marker for each information data set. This may take place, for example, in that the invitation is shown on a display, in that a suitable optical invitation appears (for example by means of a flashing LED), or in that an acoustic warning is given through a loudspeaker 2. Then the microphone 1 is activated, so that the audio marker spoken by the user can be recorded. An analog-to-digital converter (ADC) 7 is coupled to the microphone 1 in this embodiment, which ADC converts the analog electrical signals, into which the microphone 1 has converted recorded acoustic waves, into digital signals, for example with a digital resolution of 16 bits. A recorded audio marker may then be stored in digital form in the memory arrangement 3 in combination with the associated information data set, for example in that the digitized audio marker is stored in a memory module 3″, for example a memory chip, and a pointer is stored along with the digitized audio marker pointing to the start address of the information data set in the memory module 3′.

Accordingly, a digital-to-analog converter (DAC) 9 is arranged upstream of the loudspeaker 2 for converting the digitized audio marker into analog electrical signals again, so that they can be converted into acoustic waves by the loudspeaker.

Furthermore, the playback device comprises a user interface 4 and a control unit 5. For example, when a memory unit 3 is inserted into the playback device, the control unit tests how many individual songs are present on the memory unit or how many coherent groups of songs are present thereon.

The playback device of FIG. 2 also comprises a reading unit 6 for optical data carriers 10. Such an optical data carrier 10 is, for example, a CD or a DVD. Songs may be stored in compressed form (for example in MP3 format) or in uncompressed form (for example in PCM or in WAV format) on such an optical data carrier 10. A single song or a selection of songs or all songs are read from this optical data carrier 10 and stored in the memory arrangement 3. An information data set comprises a single song, the read selection of songs, or the contents of the entire CD, depending on an internal setting or depending on user instructions. Depending on the internal setting or the user instructions, the various stored information data sets may be different, i.e. for example one information data set may comprise only one song, another information data set may comprise a selection of songs—possibly also read from different data carriers—, and yet another information data set may comprise a complete CD. Furthermore, the playback device in this embodiment comprises a converter unit 8 for compressing and/or decompressing, so that the information data sets can be stored in the memory unit in a memory space saving, compressed form (for example in the ZIP format) and can be converted by the decompression part of the converter unit 8 into their original, non-compressed form before being passed on to the loudspeaker. The compression part of the converter unit 8 may also be used, for example, for converting songs read from an optical data carrier 10 into the memory space saving MP3 format. Subsequently, an additional conversion into the ZIP format may take place before an information data set is stored.

When information data sets are stored in the memory arrangement 3, the control unit 5 activates the microphone, informs the user by optical, acoustic, or haptic means (for example through vibration of a control on the steering wheel) of the fact that an audio marker is to be recorded, records the audio marker spoken (or sung or whistled) by the user, and stores it also in the memory unit 3, such that an association between the audio marker and the information data set is created, for example in the form of an assignment table in which the respective start addresses of the audio markers and those of the information data sets are jointly listed.

The playback device furthermore comprises a loudspeaker 2. According to the invention, the loudspeaker serves to reproduce the audio marker, but the loudspeaker need not be limited to this function. The loudspeaker may also be used for reproducing information data sets, in particular in the case of audio data sets, or it may serve for reproducing audio commentaries or audio requests (for example the request to record an audio marker) within a speech-controlled user interface. The use of a plurality of loudspeakers is conceivable here, for example for the simultaneous reproduction of audio data sets or audio markers, or for different purposes.

A user who wants to access an information data set may communicate this, for example, by operating a control element 4′ of the user interface 4 or by means of a speech command to the playback device. The control unit 5 then converts this by accessing the assignment table in the memory arrangement 3 and reading out the audio marker addressed by the assignment table from the memory arrangement 3 and passing it on to the loudspeaker 2, which reproduces the audio marker. If present in digitized form, the audio marker may first be converted from the digitized form into an analog form by a digital-to-analog converter (DAC) 9. If no user reaction follows (for example a further operation of a control element 4′ of the user interface 4 or a suitable speech command), the control unit 5 reads the next audio marker to which the assignment table points and reproduces it. If a user reaction follows, the control unit 5 accesses the memory unit 3 and reads the information data set belonging to the audio marker and causes this to be reproduced via the loudspeaker 2. A compressed information data set may be converted from the compressed form (for example the memory space saving ZIP compression) into an uncompressed form by the converter unit 8.

FIG. 3 diagrammatically shows a playback device according to the invention designed for a motor vehicle ambience. The playback device is shown here as viewed against the front panel 20. It comprises a display for showing information about the information data set. There is an insertion slot 21 for the insertion and ejection of CDs and there are slide compartments 22 for removable memory modules, for example flash memory cards or microdrivers. Furthermore, there are control elements 4″ on the front panel, and a further control element 4′ is on the steering wheel 30 of the vehicle, so that the user can readily carry out control operations without having to divert his/her attention from the road traffic. A microphone 1 for recording audio markers and a loudspeaker 2 for reproducing the recorded audio markers also form part of the playback device.

Two different examples of the operation of a playback device according to the invention in a motor vehicle ambiance will be given below.

1. Several compressed information data sets are already stored in MP3 format in the memory arrangement 3. Each of these information data sets has an associated audio marker which is stored in the memory arrangement 3. A user now inserts an optical data carrier into the reading unit 6. The control unit recognizes the optical data carrier and issues an audio query “Copy CD into memory?” via the loudspeaker 2. The user affirms this by operating a control element 4′ on the steering wheel 30 of the vehicle. The control unit 5 subsequently gives the audio command “Please record audio marker” via the loudspeaker 2 and switches on the microphone 1. The user now speaks an audio marker into the microphone 1, for example “pop music collection two”. The recorded audio marker is digitized in the ADC 7 and is written into an assignment table in the memory arrangement. The control unit now starts reading the CD and writing the contents thereof, after conversion into the MP3 format and compression in the conversion unit 8, into the memory arrangement.

2. The user has written information data sets in accordance with his/her own wishes into a memory module 3′, for example a flash memory card or a HDD, by means of a different appliance. Being in the vehicle, the user inserts the memory module 3′ into the slide compartment 22. The control unit 5 detects the newly inserted memory module and recognizes that there is no stored audio marker associated with the information data sets. The control unit 5 now issues the audio query “Record new audio marker?” via the loudspeaker 2. The user affirms this by operating a control element 4′. The control, unit 5 then reads part of the first information data set from the memory module and reproduces the contents via the loudspeaker 2. Then the control unit 5 gives the audio command “Please record audio marker” via the loudspeaker 2 and actives the microphone 1. The user speaks an audio marker, for example “Mozart sonata”, into the microphone 1. The control unit 5 stores the audio marker in an assignment table in the memory arrangement 3. The control unit 5 then reads a portion of the next information data set and reproduces it via the loudspeaker 2. This process is repeated until all information data sets have been given an associated, stored audio marker.

These examples serve to clarify the method of operating a playback device according to the invention and should not be regarded as restrictive. Any other speech commands are conceivable, as is an embodiment without speech commands (for example by means of haptic communication with the user by means of different vibration sequences of a control element). Alternative compression types and compression methods should also be deemed to be covered by the invention.

1. A playback device for information data sets, comprising
a microphone (1) for recording audio markers,
a memory arrangement (3) for storing the audio markers in association with the respective information data sets,
a control unit (5) coupled to the microphone and to the memory arrangement.

2. A playback device as claimed in claim 1, characterized in that it further comprises:
a loudspeaker (2) for reproducing the audio markers.

3. A playback device as claimed in claim 1, characterized in that at least one of the information data sets is stored in the memory arrangement.

4. A playback device as claimed in claim 1, characterized in that a reading unit (6) for optical data carriers (10) is present and is coupled to the control unit (5).

5. A playback device as claimed in claim 1, characterized in that it further comprises:
a user interface (4) with at least one control element (4′) for selecting an information data set.

6. A playback device as claimed in claim 1, characterized in that it comprises an analog-to-digital converter unit (7) for converting recorded audio markers into digital audio markers.

7. A playback device as claimed in claim 1, characterized in that a digital-to-analog converter unit (9) is present for converting digital audio markers into analog audio markers.

8. A playback device as claimed in claim 1, characterized in that a conversion unit (8) is present for compressing and/or decompressing information data sets.

9. A playback device as claimed in claim 1, characterized in that at least one memory module (3′) of the memory arrangement (3) is constructed such that it can be removed from the playback device.

10. A method of operating a playback device for information data sets, comprising the following steps:
recognizing an information data set without an associated audio marker,
recording an audio marker,
storing the audio marker in association with the information data set.

11. A method as claimed in claim 10, characterized in that it comprises the following steps:
reproducing an audio marker associated with an information data set,
selection of the information data set by a user.

12. A method as claimed in claim 10, characterized in that it comprises the following steps:
reading of an information data set by an optical data carrier, and
storing the information data set in uncompressed or compressed form.
